(19) United States
(12) Patent Application Publication
(10) Pub. No.: US 2021/0297589 A1
(43) Pub. Date: Sep. 23, 2021

(54) IMAGING DEVICE AND METHOD OF CONTROLLING IMAGING DEVICE

(71) Applicant: SONY SEMICONDUCTOR SOLUTIONS CORPORATION, KANAGAWA (JP)

(72) Inventor: RYUICHI TADANO, KANAGAWA (JP)

(21) Appl. No.: 16/342,398

(22) PCT Filed: Sep. 8, 2017
(86) PCT No.: PCT/JP2017/032486

§ 371 Date: Apr. 16, 2019

(30) Foreign Application Priority Data
Dec. 12, 2016 (JP) 2016-240580

(51) Int. Cl. H04N 5/232; G06T 7/70

(52) U.S. Cl. CPC H04N 5/23232; G06T 7/70

(57) ABSTRACT

To reduce a processing amount of a frame in an imaging device that images a frame. The imaging device includes a distance measuring sensor, a control unit, and an imaging unit. In this imaging device, the distance measuring sensor measures a distance for each of a plurality of regions to be imaged. Furthermore, the control unit generates a signal instructing a data rate on the basis of the distance and supplies the signal as a control signal, for each of the plurality of regions. Furthermore, the imaging unit images a frame including the plurality of regions according to the control signal.

### TECHNICAL FIELD

The present technology relates to an imaging device and a method of controlling an imaging device. Specifically, the present invention relates to an imaging device that images image data and measures a distance, and a method of controlling an imaging device.

### BACKGROUND ART

Conventionally, in imaging devices such as digital video cameras, solid-state image sensors are used for imaging image data. This solid-state image sensor is generally provided with an analog to digital converter (ADC) for each column in order to sequentially reads a plurality of rows in a pixel array and perform analog to digital (AD) conversion. However, in this configuration, resolution of an entire frame can be changed by thinning rows and columns but resolution of only a part of the frame cannot be changed. Therefore, for the purpose of changing the resolution of a part of a frame or the like, a solid-state image sensor having a pixel array divided into a plurality of areas and having an ADC arranged in each area has been proposed, for example (see Patent Document 1, for example).

### CITATION LIST

### Patent Document

### Patent Document 1: Japanese Patent Application Laid-Open No. 2016-019076

### SUMMARY OF THE INVENTION

### Problems to be Solved by the Invention

In the above-described conventional technology, a plurality of image data (frames) is sequentially imaged with constant resolution at constant imaging intervals, and moving image data including the frames can be generated. However, this conventional technology has a problem that a processing amount of a frame increases as the resolution of the entire frames and a frame rate of the moving image data become higher.

The present technology has been made in view of such a situation, and an object of the present technology is to reduce the processing amount of a frame in an imaging device that images a frame.

### Solutions to Problems

The present technology has been made to solve the above-described problems, and a first aspect of the present technology relates to an imaging device including a distance measuring sensor configured to measure a distance for each of a plurality of regions to be imaged, a control unit configured to generate a signal instructing a data rate for each of the plurality of regions on the basis of the distance and supply the signal as a control signal, and an imaging unit configured to image a frame including the plurality of regions according to the control signal, and a control method. The above configuration exerts an effect that the data rate is controlled on the basis of the distance for each of the plurality of regions.

Furthermore, in this first aspect, the data rate may include resolution. The above configuration exerts an effect that the resolution is controlled on the basis of the distance.

Furthermore, in this first aspect, the data rate may include a frame rate. The above configuration exerts an effect that the frame rate is controlled on the basis of the distance.

Furthermore, in this first aspect, the control unit may change the data rate depending on whether or not the distance is within a depth of field of an imaging lens. The above configuration exerts an effect that the data rate is changed depending on whether or not the distance is within the depth of field.

Furthermore, in this first aspect, the control unit may calculate a diameter of a circle of confusion from the distance and instruct the data rate according to the diameter. The above configuration exerts an effect that the data rate is controlled according to the diameter of the circle of confusion.

Furthermore, in this first aspect, a signal processing unit configured to execute predetermined signal processing for the frame may be further included. The above configuration exerts an effect that the predetermined signal processing is executed.

Furthermore, in this first aspect, the distance measuring sensor may include a plurality of phase difference detection pixels for detecting a phase difference of a pair of images, the imaging unit may include a plurality of normal pixels, each normal pixel receiving light, and the signal processing unit may generate the frame from an amount of received light of each of the plurality of phase difference detection pixels and the plurality of normal pixels. The above configuration exerts an effect that the frame is generated from the amount of received light of each of the plurality of phase difference detection pixels and the plurality of normal pixels.

Furthermore, in this first aspect, the distance measuring sensor may include a plurality of phase difference detection pixels for detecting a phase difference of a pair of images, the signal processing unit may generate the frame from an amount of received light of each of the plurality of phase difference detection pixels. The above configuration exerts an effect that the frame is generated from the amount of received light of each of the plurality of phase difference pixels.

### Effects of the Invention

According to the present technology, a superior effect of reducing a processing amount of a frame can be exerted in an imaging device that images a frame. Note that the effects described here are not necessarily limited, and any of effects described in the present disclosure may be exerted.

### BRIEF DESCRIPTION OF DRAWINGS

FIG. 1 is a block diagram illustrating a configuration example of an imaging device according to a first embodiment of the present technology.

FIG. 2 is a block diagram illustrating a configuration example of a solid-state image sensor according to the first embodiment of the present technology.

FIG. 3 is a block diagram illustrating a configuration example of a distance measuring sensor according to the first embodiment of the present technology.

FIG. 4 is a diagram illustrating an example of a distance to a stationary subject according to the first embodiment of the present technology.

FIG. 5 is a diagram for describing a setting example of resolution according to the first embodiment of the present technology.

FIG. 6 is a diagram illustrating an example of a distance to a moving subject according to the first embodiment of the present technology.

FIG. 7 is a diagram for describing a setting example of a frame rate according to the first embodiment of the present technology.

FIG. 8 is a flowchart illustrating an example of an operation of the imaging device according to the first embodiment of the present technology.

FIG. 9 is a block diagram illustrating a configuration example of an imaging device according to a second embodiment of the present technology.

FIG. 10 is a block diagram illustrating a configuration example of a lens unit according to the second embodiment of the present technology.

FIG. 11 is a block diagram illustrating a configuration example of an imaging control unit according to the second embodiment of the present technology.

FIG. 12 is a diagram for describing a setting example of resolution according to the second embodiment of the present technology.

FIG. 13 is a diagram illustrating an example of a focal position and a depth of field according to the second embodiment of the present technology.

FIG. 14 is a flowchart illustrating an example of an operation of the imaging device according to the second embodiment of the present technology.

FIG. 15 is a diagram for describing a method of calculating a circle of confusion according to a third embodiment of the present technology.

FIG. 16 is a block diagram illustrating a configuration example of an imaging device according to a fourth embodiment of the present technology.

FIG. 17 is a plan view illustrating a configuration example of a pixel array unit according to the fourth embodiment of the present technology.

FIG. 18 is a plan view illustrating a configuration example of a phase difference pixel according to the fourth embodiment of the present technology.

FIG. 19 is a plan view illustrating a configuration example of a pixel array unit according to a modification of the fourth embodiment of the present technology.

FIG. 20 is a block diagram illustrating an example of a schematic configuration of a vehicle control system.

FIG. 21 is an explanatory diagram illustrating an example of installation positions of a vehicle exterior information detection unit and an imaging unit.

### MODE FOR CARRYING OUT THE INVENTION

Hereinafter, modes for implementing the present technology (hereinafter referred to as embodiments) will be described. Description will be given according to the following order.

1. First embodiment (an example of controlling a data rate on the basis of a distance)

2. Second embodiment (an example of lowering a data rate within a depth of field)

3. Third embodiment (an example of controlling to a data rate according to a diameter of a circle of confusion calculated from a distance)

4. Fourth embodiment (an example of controlling a data rate on the basis of a distance obtained with a phase difference pixel)

5. Application examples to moving bodies

### 1. First Embodiment

### [Configuration Example of Imaging Device]

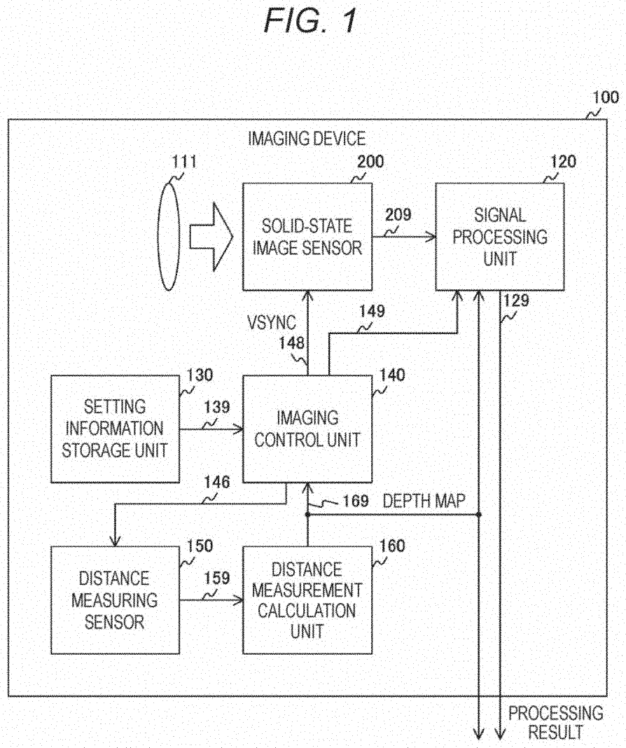

FIG. 1 is a block diagram illustrating a configuration example of an imaging device 100 according to a first embodiment of the present technology. The imaging device 100 is a device that images image data (frame), and includes an imaging lens 111, a solid-state image sensor 200, a signal processing unit 120, a setting information storage unit 130, an imaging control unit 140, a distance measuring sensor 150, and a distance measurement calculation unit 160. As the imaging device 100, a smartphone, a personal computer, or the like, having an imaging function, in addition to a digital video camera or a surveillance camera, is assumed.

The imaging lens 111 condenses light from a subject and guides the light to the solid-state image sensor 200.

The solid-state image sensor 200 images a frame in synchronization with a predetermined vertical synchronization signal VSYNC according to control of the imaging control unit 140. The vertical synchronization signal VSYNC is a signal indicating imaging timing, and a periodic signal having a predetermined frequency (for example, 60 hertz) is used as the vertical synchronization signal VSYNC. The solid-state image sensor 200 supplies the imaged frame to the signal processing unit 120 via a signal line 209. This frame is divided into a plurality of unit areas. Here, the unit area is a unit for controlling resolution or a frame rate in the frame, and the solid-state image sensor 200 can control the resolution or the frame rate for each unit area. Note that the solid-state image sensor 200 is an example of an imaging unit described in the claims.

The distance measuring sensor 150 measures a distance to a subject with respect to each of the plurality of unit areas to be imaged in synchronization with the vertical synchronization signal VSYNC. The distance measuring sensor 150 measures the distance by, for example, the time-of-flight (ToF) method. Here, the ToF method is a distance measuring method of radiating irradiation light, receiving reflected light with respect to the irradiation light, and measuring the distance from a phase difference between the irradiation light and the reflected light. The distance measuring sensor 150 supplies data indicating the amount of received light of each unit area to the distance measurement calculation unit 160 via a signal line 159.

The distance measurement calculation unit 160 calculates a distance corresponding to each unit area from the amount of received light of the unit area. The distance measurement calculation unit 160 generates a depth map in which the distance of each unit area is arrayed and outputs the depth map to the imaging control unit 140 and the signal processing unit 120 via a signal line 169. Furthermore, the depth map is output to the outside of the imaging device 100 as necessary. Note that the distance measurement calculation unit 160 is arranged outside the distance measuring sensor 150. However, a configuration having the distance measurement calculation unit 160 arranged inside the distance measuring sensor 150 may be adopted.

Note that the distance measuring sensor 150 measures the distance by the ToF method, but the distance measuring sensor 150 may measure the distance by a method other than the ToF method as long as the distance can be measured for each unit area.

The setting information storage unit 130 stores setting information indicating a reference value used for controlling a data rate. Here, the data rate is a parameter indicating a data amount per unit time, and is specifically the frame rate, the resolution, or the like. As the setting information, for example, a maximum value Lₘₐₓ of the distance in which the signal processing unit 120 can detect a specific object (such as a face) under the maximum resolution is set. Alternatively, a minimum value Fₘᵢₙ of the frame rate at which the signal processing unit 120 can detect a specific object (such as a vehicle) passing through a position of a predetermined distance Lc from the imaging device 100 at a predetermined speed, and the distance Lc are set.

The imaging control unit 140 controls the data rate for each of the unit areas in the frame on the basis of the distance corresponding to that area. The imaging control unit 140 reads the setting information from the setting information storage unit 130 via a signal line 139 and controls the data rate for each unit area on the basis of the setting information and the depth map. Here, the imaging control unit 140 may control either one of the resolution and the frame rate, or may control both of the resolution and the frame rate.

In the case of controlling the resolution, the imaging control unit 140 increases the number of pixels (in other words, the resolution) of the unit area corresponding to the distance as the distance is longer, for example. Specifically, the imaging control unit 140 controls the resolution of the corresponding unit area to a value Rm expressed by the following expression, where a maximum value of the resolution is Rₘₐₓ and a measured distance is Lm.

Rm=(Lm/Lₘₐₓ)×Rₘₐₓ Expression 1

In the above expression, the unit of the distances Lm and Lₘₐₓ is, for example, meter (m). Note that it is assumed that the maximum value Rₘₐₓ is set as the resolution in a case where the right side of Expression 1 exceeds the Rₘₐₓ.

Furthermore, in a case of controlling the frame rate, the imaging control unit 140 decreases the frame rate of the unit area corresponding to the distance as the distance is longer, for example. Specifically, the imaging control unit 140 controls the resolution of the corresponding unit area to Fm expressed by the following expression, where the measured distance is Lm.

Fm=Fₘᵢₙ×Lc/Lm Expression 2

In the above expression, the unit of the frame rates Fm and Fₘᵢₙ is, for example, Hertz (Hz). Note that it is assumed that a lower limit value of the frame rate is set to Fm in a case where the right side of Expression 2 becomes smaller than the lower limit value.

Note that the imaging control unit 140 increases the resolution as the distance is longer. However, the resolution may be decreased as the distance is longer to the contrary. Furthermore, the imaging control unit 140 decreases the frame rate as the distance is longer. However, the resolution may be increased as the distance is longer to the contrary. The method of controlling the resolution and the frame rate is determined in response to a request of an application using a frame.

The imaging control unit 140 generates a control signal instructing the value of the data rate obtained by Expression 1 or Expression 2 and the vertical synchronization signal VSYNC, and supplies the generated signals to the solid-state image sensor 200 via a signal line 148. Furthermore, the imaging control unit 140 supplies the control signal instructing the data rate or the like to the signal processing unit 120 via a signal line 149. Furthermore, the imaging control unit 140 supplies the vertical synchronization signal VSYNC to the distance measuring sensor 150 via a signal line 146. Note that the imaging control unit 140 is an example of a control unit described in the claims.

The signal processing unit 120 executes predetermined signal processing for the frame from the solid-state image sensor 200. For example, demosaicing processing, processing for detecting a specific object (such as a face or a vehicle) is executed. The signal processing unit 120 outputs a processing result to the outside via a signal line 129.

[Configuration Example of Solid-State Image Sensor]

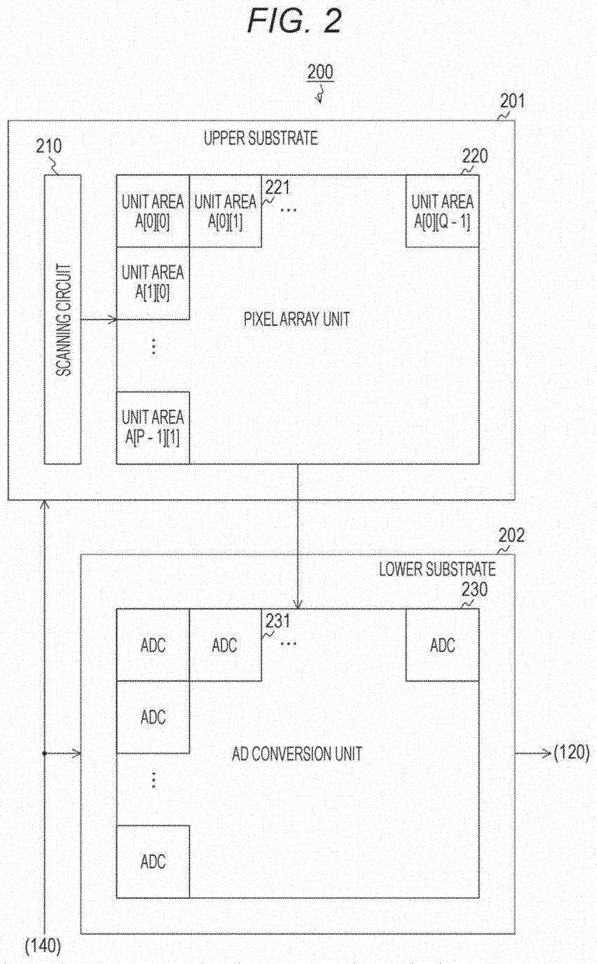

FIG. 2 is a block diagram illustrating a configuration example of the solid-state image sensor 200 according to the first embodiment of the present technology. The solid-state image sensor 200 includes an upper substrate 201 and a lower substrate 202 that are stacked. The upper substrate 201 is provided with a scanning circuit 210 and a pixel array unit 220. Furthermore, the lower substrate 202 is provided with an AD conversion unit 230.

The pixel array unit 220 is divided into a plurality of unit areas 221. In each of the unit areas 221, a plurality of pixels is arrayed in a two-dimensional lattice manner. Each of the pixels photoelectrically converts light according to control of the scanning circuit 210 to generate analog pixel data and outputs the analog pixel data to the AD conversion unit 230.

The scanning circuit 210 drives each of the pixels to output the pixel data. The scanning circuit 210 controls at least one of the frame rate or the resolution for each of the unit areas 221 according to the control signal. For example, in a case of controlling the frame rate by 1/J (J is a real number) times the frame rate of the vertical synchronization signal VSYNC, the scanning circuit 210 drives the corresponding unit area 221 every time a cycle that is J times the cycle of the vertical synchronization signal VSYNC passes. Furthermore, in a case where the number of pixels in the unit area 221 is M (M is an integer) and the resolution is controlled to 1/K (K is a real number) times the maximum value, the scanning circuit 210 selects and drives only M/K out of the M pixels in the corresponding unit area.

The AD conversion unit 230 is provided with the same number of ADCs 231 as the number of unit areas 221. The ADCs 231 are respectively connected to the different unit areas 221 from one another on a one-to-one basis. When the number of unit areas 221 is P×Q, P×Q ADCs 231 are also arranged. The ADC 231 performs AD conversion for the analog pixel data from the corresponding unit area 221 to generate digital pixel data. A frame in which these digital pixel data are arrayed is output to the signal processing unit 120.

[Configuration Example of Distance Measuring Sensor]

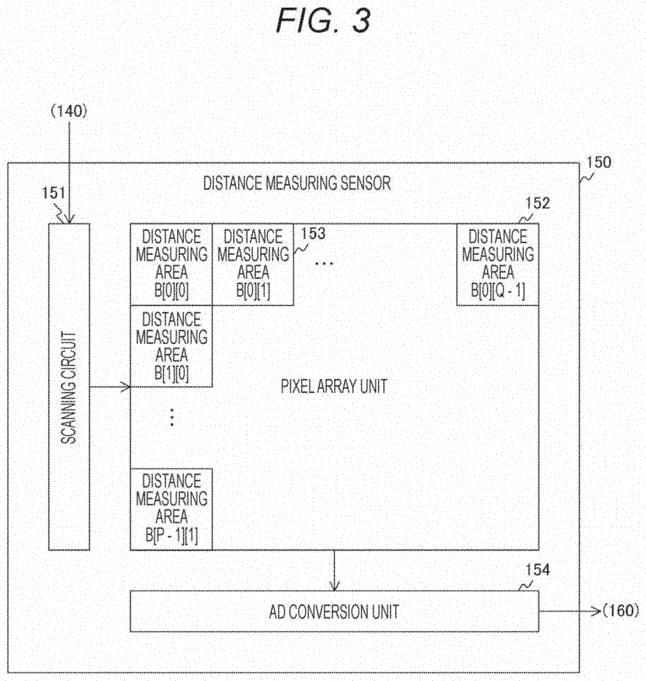

FIG. 3 is a block diagram illustrating a configuration example of the distance measuring sensor 150 according to the first embodiment of the present technology. The distance measuring sensor 150 includes a scanning circuit 151, a pixel array unit 152, and an AD conversion unit 154.

The pixel array unit 152 is divided into a plurality of distance measuring areas 153. It is assumed that the respective distance measuring areas 153 corresponds to the different unit areas 221 from one another on a one-to-one basis. In each of the distance measuring areas 153, a plurality of pixels is arrayed in a two-dimensional lattice manner. Each of the pixels photoelectrically converts light according to control of the scanning circuit 151 to generate data indicating an analog amount of received light and outputs the analog amount of received light to the AD conversion unit 154.

Note that the correspondence relationship between the distance measuring area 153 and the unit area 221 is not limited to one to one. For example, a configuration in which a plurality of unit areas 221 corresponds to one distance measuring area 153 may be adopted. Furthermore, a configuration in which a plurality of distance measuring areas 153 corresponds to one unit area 221 may be adopted. In this case, as the distance of the unit area 221, an average of respective distances of the plurality of corresponding distance measuring areas 153 is used.

The AD conversion unit 154 performs AD conversion for the analog data from the pixel array unit 152 and supplies the converted data to the distance measurement calculation unit 160.

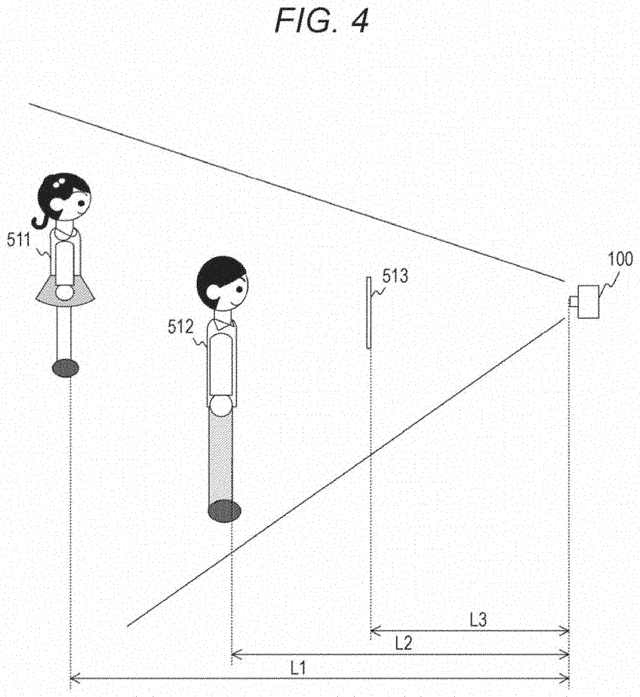

FIG. 4 is a diagram illustrating an example of a distance to a stationary subject according to the first embodiment of the present technology. For example, it is assumed that the imaging device 100 images subjects 511, 512, and 513. Furthermore, the distance from the imaging device 100 to the subject 511 is L1. Moreover, the distance from the imaging device 100 to the subject 512 is L2, and the distance from the imaging device 100 to the subject 513 is L3. For example, it is assumed that the distance L1 is the largest and the distance L3 is the smallest.

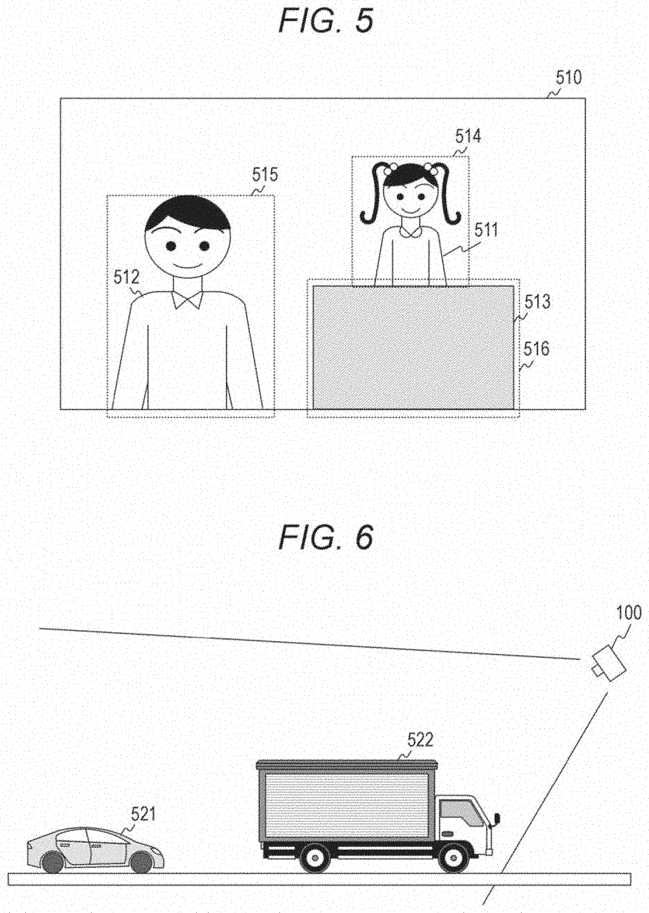

FIG. 5 is a diagram for describing a setting example of the resolution according to the first embodiment of the present technology. It is assumed that, in the frame of the imaged subjects illustrated in FIG. 4, the resolution of a rectangular region 514 including the subject 511 is R1, and the resolution of a rectangular region 515 including the subject 512 is R2. Furthermore, it is assumed that the resolution of a rectangular region 516 including the subject 513 is R3, and the resolution of a remaining region 510 other than the regions 514, 515, and 516 is R0. Each of these regions includes the unit area 221.

The imaging control unit 140 calculates the resolution R0, R1, R2, and R3 from the distances corresponding to the respective regions using Expression 1. As a result, a highest value is set to R0 among the resolution R0, R1, R2, and R3, and lower values are set in the order of R1, R2, and R3. The reason why lower resolution is set to a shorter distance in this manner is that, in general, a subject is taken in a larger way as the distance is shorter (in other words, closer), and a possibility of failing detection of an object is low even if the resolution is low.

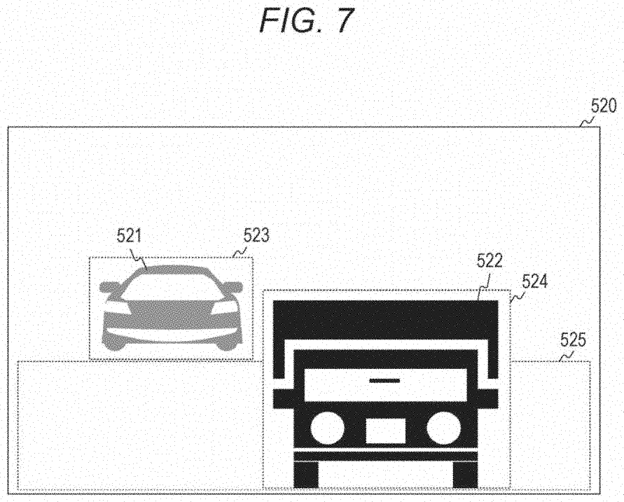

FIG. 6 is a diagram illustrating an example of a distance to a moving subject according to the first embodiment of the present technology. For example, it is assumed that the imaging device 100 images vehicles 521 and 522. Furthermore, it is assumed that the vehicle 522 is closer to the imaging device 100 than the vehicle 521.

FIG. 7 is a diagram for describing a setting example of a frame rate according to the first embodiment of the present technology. It is assumed that, in the frame of the imaged subjects in FIG. 6, the frame rate of a rectangular region 523 including the vehicle 521 is F1 and the frame rate of a rectangular region 524 including the vehicle 522 is set to F2. Furthermore, it is assumed that the frame rate of a region 525 including a relatively close place, of a background region other than the regions 523 and 524, is set to F3, and the frame rate of a remaining region 520 other than the regions 523, 524, and 525 is set to F0.

The imaging control unit 140 calculates the frame rates F0, F1, F2, and F3 from the distances corresponding to the respective regions using Expression 2. As a result, among the frame rates F0, F1, F2 and F3, the highest value is set for F3, and low values are set in the order of F2, F1 and F0. The reason why a higher frame rate is set to a shorter distance in this manner is that, in general, time to pass through the imaging device 100 by a subject is shorter as the distance is closer, and there is a possibility of failing detection of an object if the frame rate is low.

[Operation Example of Imaging Device]

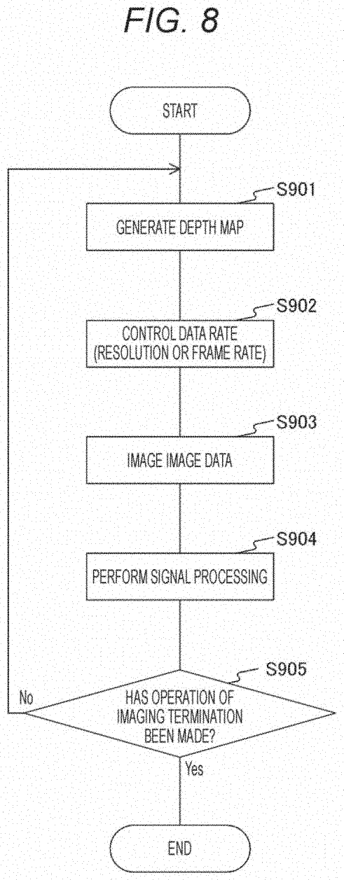

FIG. 8 is a flowchart illustrating an example of an operation of the imaging device 100 according to the first embodiment of the present technology. This operation is started when, for example, an operation (pressing of a shutter button, or the like) for starting imaging is performed in the imaging device 100. First, the imaging device 100 generates a depth map (step S901). Then, the imaging device 100 controls the data rates (the resolution and the frame rate) for each unit area on the basis of the depth map (step S902).

The imaging device 100 images image data (frame) (step S903), and executes the signal processing for the frame (step S904). Then, the imaging device 100 determines whether or not an operation for terminating imaging has been performed (step S905). In a case where the operation for terminating imaging has not been performed (step S905: No), the imaging device 100 repeatedly executes the processing of step S901 and the subsequent steps. On the other hand, in a case where the operation for terminating imaging has been performed (step S905: Yes), the imaging device 100 terminates the operation for imaging.

As described above, according to the first embodiment of the present technology, the imaging device 100 controls the data rate on the basis of the distance for each unit area. Therefore, the imaging device 100 can perform control to set the data rate for each unit area to a necessary minimum value, thereby controlling an increase in the processing amount.

### 2. Second Embodiment

In the above-described first embodiment, the imaging device 100 has decreased the resolution on the assumption that the subject is taken in a larger way as the distance is shorter and the visibility is improved. However, there is a case where the visibility of a subject is high even in a case where the distance is long. For example, even in a case where the distance is long, the visibility becomes high because a subject is in focus in a case where the distance is within a depth of field. Therefore, it is desirable to change the resolution depending on whether or not the distance is within the depth of field. An imaging device 100 according to a second embodiment is different from the first embodiment in changing resolution depending on whether or not a distance is within a depth of field.

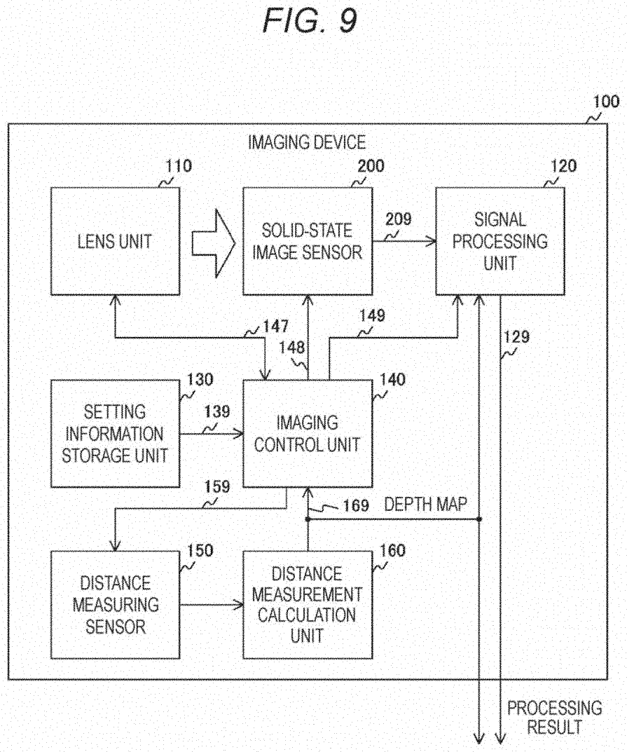

FIG. 9 is a block diagram illustrating a configuration example of the imaging device 100 according to the second embodiment of the present technology. The imaging device 100 according to the second embodiment is different from the first embodiment in including a lens unit 110.

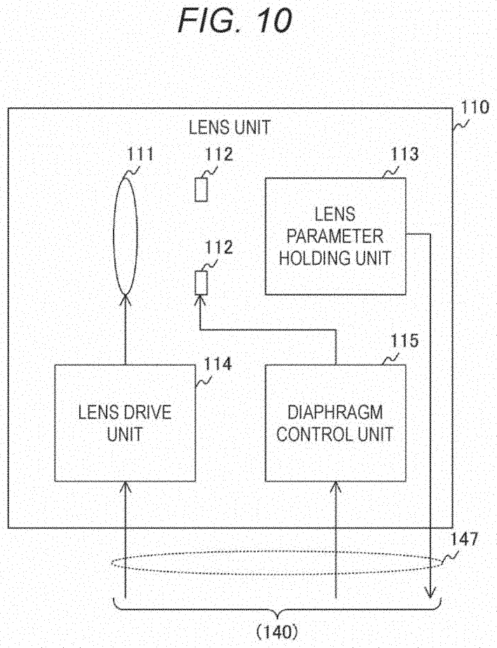

FIG. 10 is a block diagram illustrating a configuration example of the lens unit 110 according to the second embodiment of the present technology. The lens unit 110 includes an imaging lens 111, a diaphragm 112, a lens parameter holding unit 113, a lens drive unit 114, and a diaphragm control unit 115.

The imaging lens 111 includes various lenses such as a focus lens and a zoom lens, for example. The diaphragm 112 is a shielding member that adjusts the amount of light to pass through the imaging lens 111.

The lens parameter holding unit 113 holds various lens parameters such as a diameter c₀ of a permissible circle of confusion and a control range of a focal length f.

The lens drive unit 114 drives the focus lens and the zoom lens in the imaging lens 111 according to control of an imaging control unit 140.

The diaphragm control unit 115 controls a diaphragm amount of the diaphragm 112 according to the control of the imaging control unit 140.

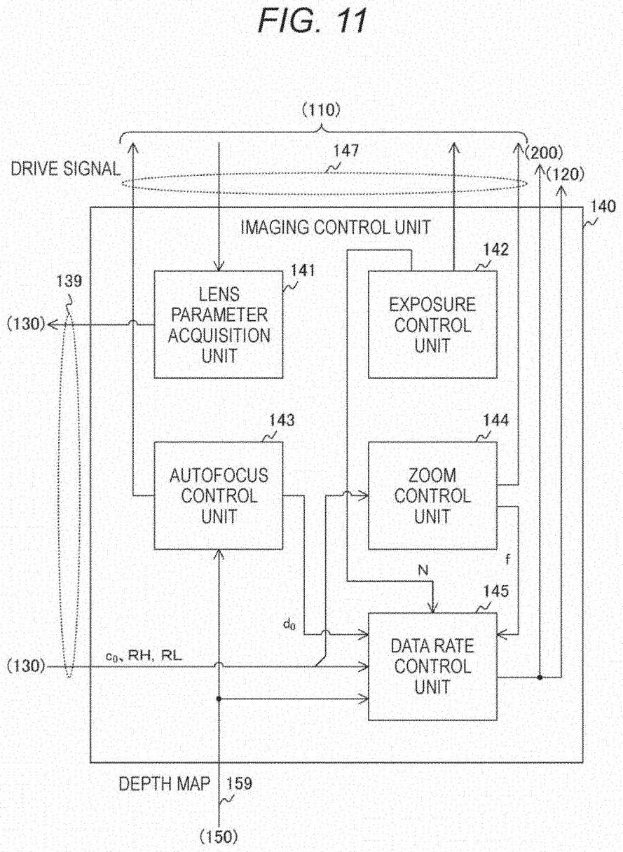

FIG. 11 is a block diagram illustrating a configuration example of the imaging control unit 140 according to the second embodiment of the present technology. The imaging control unit 140 according to the second embodiment includes a lens parameter acquisition unit 141, an exposure control unit 142, an autofocus control unit 143, a zoom control unit 144, and a data rate control unit 145.

The lens parameter acquisition unit 141 acquires the lens parameters in advance from the lens unit 110 before imaging. The lens parameter acquisition unit 141 causes a setting information storage unit 130 to store the acquired lens parameters.

In the second embodiment, the setting information storage unit 130 stores the lens parameters and resolution RH and RL as setting information. Here, RL is resolution in imaging a subject within the depth of field and RH is resolution in imaging a subject outside the depth of field. The resolution RH is set to a value higher than the resolution RL, for example.

The exposure control unit 142 controls an exposure amount on the basis of a photometric amount. In exposure control, the exposure control unit 142 determines, for example, a diaphragm value N, and supplies a control signal indicating the value to the lens unit 110 via a signal line 147. Furthermore, the exposure control unit 142 supplies the diaphragm value N to the data rate control unit 145. Note that the exposure control unit 142 may supply the control signal to a solid-state image sensor 200 to control a shutter speed.

The autofocus control unit 143 focuses on a subject according to an operation of a user. When a focus point is specified by the user, the autofocus control unit 143 acquires a distance dₒ corresponding to the focus point from a depth map. Then, the autofocus control unit 143 generates a drive signal for driving the focus lens to a position where the distance dₒ is in focus, and supplies the drive signal to the lens unit 110 via the signal line 147. Furthermore, the autofocus control unit 143 supplies the distance dₒ to the focused subject to the data rate control unit 145.

The zoom control unit 144 controls the focal length f according to a zoom operation by the user. The zoom control unit 144 sets the focal length f within the control range indicated by the lens parameter according to the zoom operation. Then, the zoom control unit 144 generates a drive signal for driving the zoom lens and the focus lens to a position corresponding to the set focal length f, and supplies the drive signal to the lens unit 110. Here, the focus lens and the zoom lens are controlled along a cam curve showing a locus of when the zoom lens is driven in a focused state. Furthermore, the zoom control unit 144 supplies the set focal length f to the data rate control unit 145.

The data rate control unit 145 controls the data rate for each unit area 221 on the basis of the distance. The data rate control unit 145 calculates a front end D_{N} and a rear end D_{F} of the depth of field by, for example, the following expressions with reference to the lens parameters.

H≈f/(Nc₀) Expression 3

D_{N}≈dₒ(H−f)/(H+dₒ−2f) Expression 4

D_{F}≈dₒ(H−f)/(H−dₒ) Expression 5

Then, the data rate control unit 145 determines whether or not a corresponding distance Lm is within a range from the front end D_{N} to the rear end D_{F} (in other words, within the depth of field) for each unit area 221 with reference to the depth map. The data rate control unit 145 sets the lower resolution RL in the unit area 221 in a case where the distance Lm is within the depth of field, and sets the higher resolution RH in the unit area 221 in a case where the distance Lm is outside the depth of field. Then, the data rate control unit 145 supplies control signals indicating the resolution of the respective unit areas 221 to the solid-state image sensor 200 and a signal processing unit 120.

Note that the imaging control unit 140 switches the resolution and the like depending on whether or not the distance is within the depth of field, but in general, the degree of sharpness becomes larger as the distance is closer to the focused distance dₒ and the degree of blurring becomes larger as the distance is far from the focused distance dₒ. Therefore, the imaging control unit 140 may decrease the resolution as the distance is closer to the distance dₒ and may increase the resolution as the distance is farther. Furthermore, the imaging control unit 140 changes the resolution depending on whether or not the subject is within the depth of field. However, the imaging control unit 140 may change the frame rate instead of the resolution.

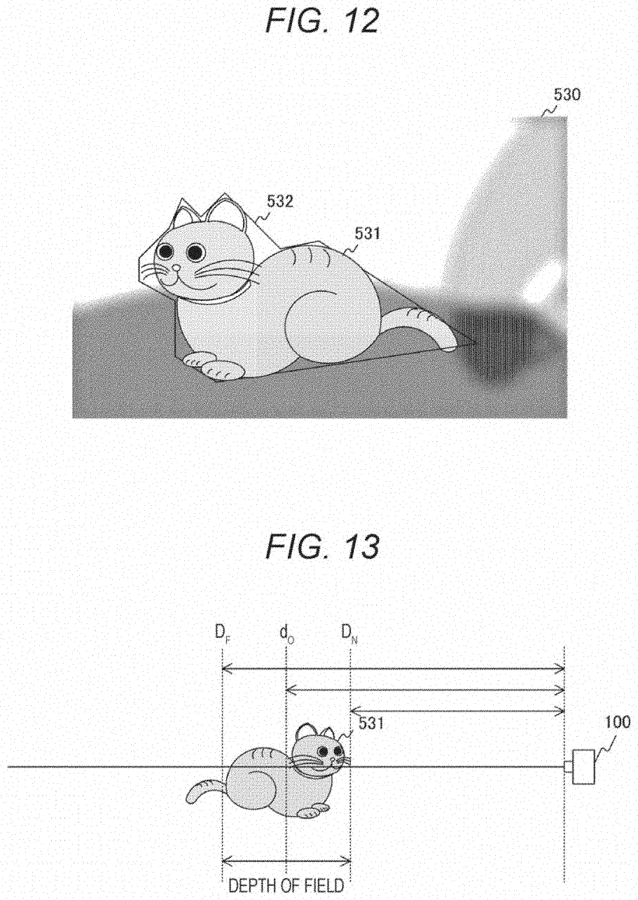

FIG. 12 is a diagram for describing a setting example of the resolution according to the second embodiment of the present technology. It is assumed that a subject 531 is in focus in a frame 530. Therefore, a region 532 including the subject 531 is sharp, and the other region is blurred. The distance (depth) corresponding to the region 532 is within the depth of field. The imaging device 100 sets the lower resolution RL in the region 532 within the depth of field and sets the higher resolution RH in the other region. The reason why the resolution of the region within the depth of field is decreased in this way is that the region is in focus and taken in a sharp manner, a possibility of insufficient detection accuracy is low even if the resolution is decreased.

FIG. 13 is a diagram illustrating an example of a focal position and the depth of field according to the second embodiment of the present technology. In a case where the user wants to focus on the subject 531, the user operates the imaging device 100 to move the focus point to the position of the subject 531. The imaging device 100 drives the focus lens to focus on the distance dₒ corresponding to the focus point. As a result, an image focused within the depth of field from the front end D_{N} in front of the distance dₒ to the rear end D_{F} is formed on the solid-state image sensor 200. The imaging device 100 images the frame in which the resolution of the focused region is decreased.

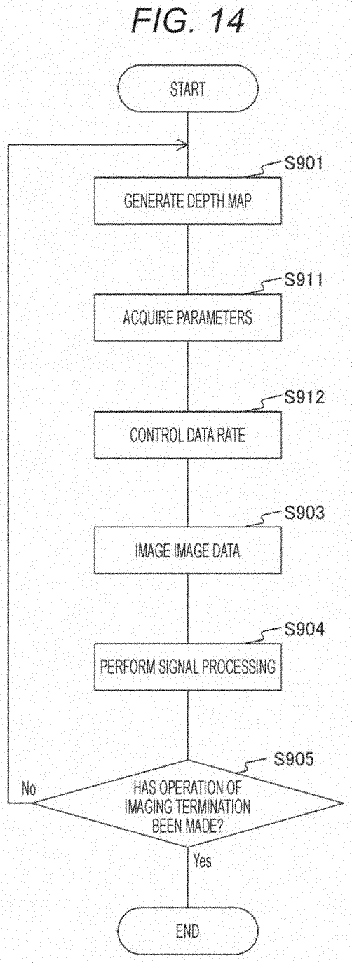

FIG. 14 is a flowchart illustrating an example of an operation of the imaging device according to the second embodiment of the present technology. The imaging device 100 generates the depth map (step S901), and acquires the parameters such as the distance dₒ and the focal length f (step S911). Then, the imaging device 100 calculates the front end D_{N} and the rear end D_{F} of the depth of field using Expressions 3 to 5, and changes the data rate depending on whether or not the distance Lm (depth) in the depth map is within the depth of field (step S912). After step S912, the imaging device 100 executes step S903 and subsequent steps.

As described above, in the second embodiment of the present technology, the resolution is changed depending on whether or not the distance is within the depth of field. Therefore, the data rate of the focused region can be changed.

### 3. Third Embodiment

In the above-described second embodiment, the imaging device 100 has reduced the data rate (for example, the resolution) to the constant value RL on the assumption that the subject is sharply taken when the distance is within the depth of field. However, the degree of sharpness is not necessarily constant. In general, the circle of confusion becomes smaller and the degree of sharpness becomes higher as a subject gets closer to a focused distance (depth) dₒ, whereas the degree of sharpness becomes lower as the subject gets away from the distance dₒ. Therefore, it is desirable to change resolution according to the degree of sharpness. An imaging device 100 according to a third embodiment is different from the second embodiment in controlling the resolution according to the degree of sharpness.

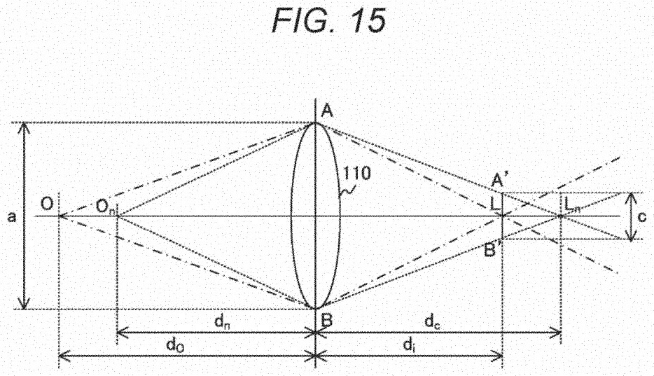

FIG. 15 is a diagram for describing a method of calculating the circle of confusion according to the third embodiment of the present technology. It is assumed that the imaging device 100 focuses on a certain distance dₒ. It is assumed that a distance closer to an imaging lens 111 than the distance dₒ is dₙ. In FIG. 15, the alternate long and short dashed line illustrates a ray from a position O at the distance dₒ. Light from this position O is focused by the imaging lens 111 on a position L on an image side with respect to the imaging lens 111. The distance from the imaging lens 111 to the position L is dᵢ.

Furthermore, the dotted line illustrates a ray from a position Oₙ of the distance dₙ. Light from the position Oₙ is focused by the imaging lens 111 on a position Lₙ on an image side with respect to the imaging lens 111. The distance from the imaging lens 111 to the position Lₙ is d_{c}.

Here, it is assumed that an aperture size of the imaging lens 111 is a and the diameter of the circle of confusion at the position Lₙ is c. Furthermore, it is assumed that one of both ends of the aperture size is denoted by A and the other is denoted by B. It is assumed that one of both ends of the circle of confusion is denoted by A′ and the other is denoted by B′. In this case, since a triangle formed by A′, B′, and Lₙ and a triangle formed by A, B, and Lₙ are similar, the following expression holds.

a:c=d_{c}:d_{c}−dᵢ Expression 6

Expression 6 can be transformed into the following expression.

c=a(d_{c}−dᵢ)/d_{c} Expression 7

Here, from the formula of lens, the following expressions are obtained.

d_{c}=dₙf/(dₙ−f) Expression 8

dᵢ=dₒf/(dₒ−f) Expression 9

By substituting the right side of Expressions 8 and 9 into Expression 7, the following expression is obtained.

c=af(dₒ−dₙ)/{dₙ(dₒ−f)} Expression 10

A configuration of an imaging control unit 140 of the third embodiment is similar to the configuration of the second embodiment. However, the imaging control unit 140 substitutes, for each unit area 221, a value of a distance Lm corresponding to the area into dₒ in Expression 10 to calculate a diameter c of the circle of confusion. Then, the imaging control unit 140 calculates resolution Rm by the following expression.

Rm=(c/c₀)×RH Expression 11

In the above expression, c₀ is a diameter of a permissible circle of confusion, and this c₀ is stored in a setting information storage unit 130.

According to Expression 11, lower resolution is set as the diameter of the circle of confusion is smaller in the depth of field. The reason why control is performed in such a manner is that the degree of sharpness of an image becomes higher as the circle of confusion is smaller, and a possibility of a decrease in detection accuracy is small even if the resolution is decreased.

Note that, in a case where the diameter c of the circle of confusion exceeds the diameter c₀ of the permissible circle of confusion, high resolution RH is set because of outside the depth of field. Furthermore, the imaging control unit 140 controls the resolution according to the diameter of the circle of confusion. However, the imaging control unit 140 can also control the frame rate instead of the resolution.

As described above, in the third embodiment of the present technology, the imaging device 100 controls the resolution to lower resolution as the diameter of the circle of confusion is smaller (in other words, the degree of sharpness of the image is higher). Therefore, the data rate can be controlled according to the degree of sharpness.

### 4. Fourth Embodiment

In the above-described first embodiment, the distance has been measured by the distance measuring sensor 150 provided outside the solid-state image sensor 200. However, the distance can be measured without providing the distance measuring sensor 150 by an image plane phase difference method. Here, the image plane phase difference method is a method of arranging a plurality of phase difference pixels for detecting a phase difference between a pair of pupil-divided images in a solid-state image sensor, and measuring a distance from the phase difference. An imaging device 100 according to a fourth embodiment is different from the first embodiment in measuring a distance by the image plane phase difference method.

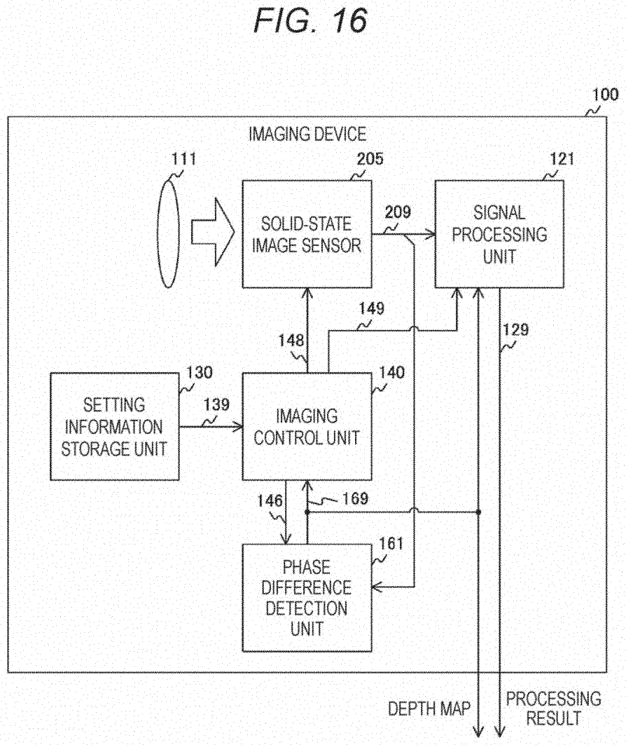

FIG. 16 is a block diagram illustrating a configuration example of the imaging device 100 according to the fourth embodiment of the present technology. The imaging device 100 according to the fourth embodiment is different from the first embodiment in including a solid-state image sensor 205 in place of the solid-state image sensor 200 and the distance measuring sensor 150, and a phase difference detection unit 161 in place of the distance measurement calculation unit 160. Furthermore, the imaging device 100 according to the fourth embodiment includes a signal processing unit 121 in place of the signal processing unit 120.

A plurality of phase difference pixels and pixels (hereinafter referred to as “normal pixels”) other than the phase difference pixels are arrayed in a pixel array unit 220 in the solid-state image sensor 205. The solid-state image sensor 205 supplies data indicating the amount of received light of the phase difference pixel to the phase difference detection unit 161.

The phase difference detection unit 161 detects a phase difference between a pair of pupil-divided images from the amount of received light of each of the plurality of phase difference pixels. The phase difference detection unit 161 calculates a distance of each positioning area from the phase difference, and generates a depth map.

Furthermore, the signal processing unit 121 generates pixel data of the pixel from the amount of received light of the phase difference pixel.

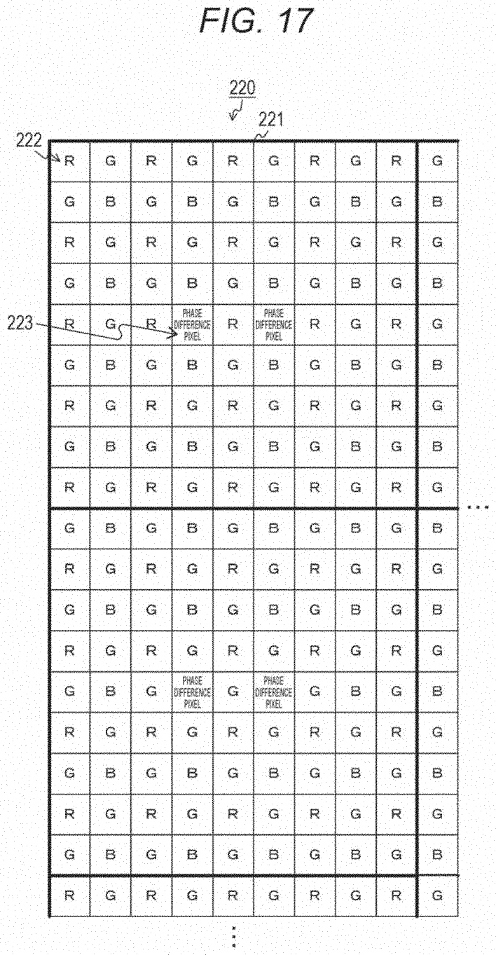

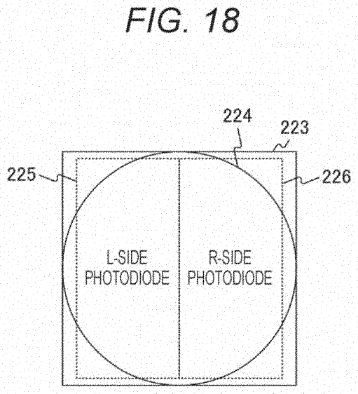

FIG. 17 is a plan view illustrating a configuration example of the pixel array unit 220 according to the fourth embodiment of the present technology. In the pixel array unit 220, a plurality of normal pixels 222 and a plurality of phase difference pixels 223 are arrayed. As the normal pixels 222, red (R) pixels that receive red light, green (G) pixels that receive green light, and blue (B) pixels that receive blue light are arranged in a Bayer array, for example. Furthermore, two phase difference pixels 223 are arranged in each unit area 221, for example. With the phase difference pixels 223, the solid-state image sensor 205 can measure the distance by the image plane phase difference method.

Note that a circuit including the phase difference pixel 223, a scanning circuit 210, and an AD conversion unit 230 is an example of a distance measuring sensor described in the claims, and a circuit including the normal pixel 222, the scanning circuit 210, and the AD conversion unit 230 is an example of an imaging unit described in the claims.

FIG. 18 is a plan view illustrating a configuration example of the phase difference pixel 223 according to the fourth embodiment of the present technology. A microlens 224, an L-side photodiode 225, and an R-side photodiode 226 are arranged in the phase difference pixel 223.

The microlens 224 collects light of any of R, G, and B. The L-side photodiode 225 photoelectrically converts light from one of two pupil-divided images, and the R-side photodiode 226 photoelectrically converts light from the other of the two images.

The phase difference detection unit 161 acquires a left-side image from the amount of received light of each of a plurality of the L-side photodiodes 225 arrayed along a predetermined direction, and acquires a right-side image from the amount of received light of each of a plurality of the R-side photodiodes 226 arrayed along the predetermined direction. The phase difference between a pair of these images is generally larger as the distance is shorter. The phase difference detection unit 161 calculates the distance from the phase difference between the pair of images on the basis of this property.

Furthermore, the signal processing unit 121 calculates, for each phase difference pixel 223, an addition value or an addition average between the amount of received light of the L-side photodiode 225 and the amount of received light of the R-side photodiode 226 inside the phase difference pixel 223, and sets the calculated value as pixel data of any of R, G, and B.

Here, in a general phase difference pixel, a part of the phase difference pixel is shielded, and only one photodiode is arranged. In such a configuration, pixel data of the phase difference pixel is missing in generating image data (frame), so interpolation from surrounding pixels is necessary. In contrast, in the configuration of the phase difference pixel 223 in which the L-side photodiode 225 and the R-side photodiode 226 are provided without light shielding, pixel data is not missing and interpolation processing need not be performed. Therefore, the image quality of the frame can be improved.

As described above, in the fourth embodiment of the present technology, the imaging device 100 measures the distance from the phase difference detected by the phase difference pixel 223. Therefore, the depth map can be generated without arranging a distance measuring sensor. As a result, cost and circuit scale can be reduced by the distance measuring sensor.

[Modification]

In the above-described fourth embodiment, the two phase difference pixels 223 have been arranged for each unit area 221. However, distance measurement accuracy may be insufficient with the two phase difference pixels for each unit area 221. An imaging device 100 according to a modification of the fourth embodiment is different from the fourth embodiment in that the distance measurement accuracy has been improved.

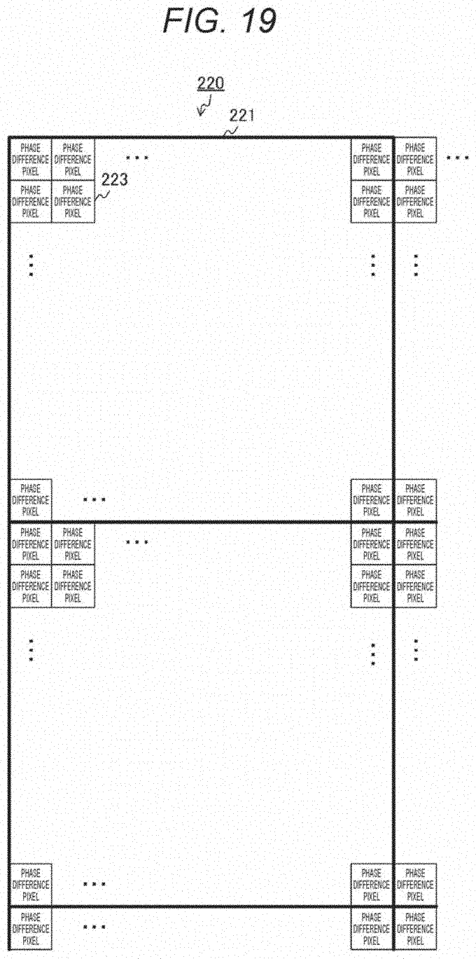

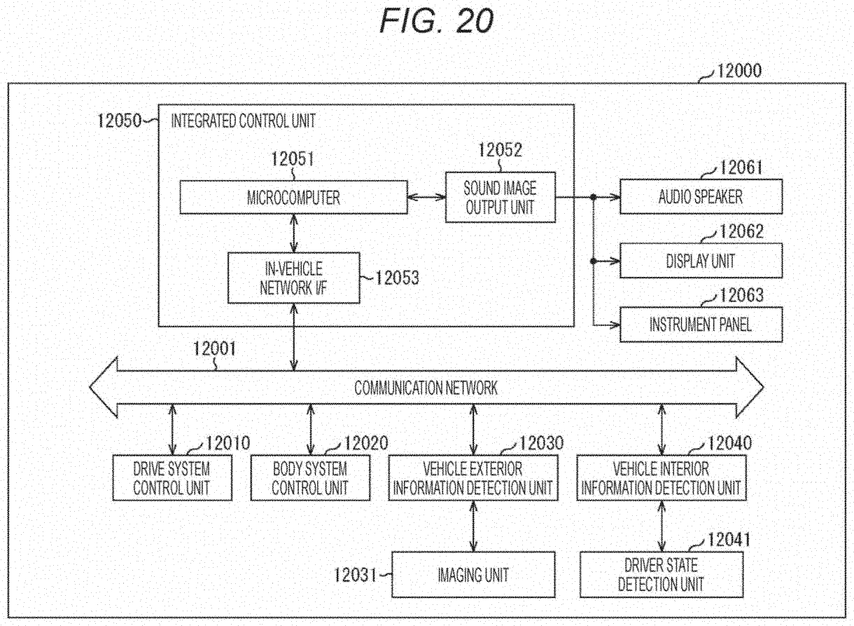

FIG. 19 is a plan view illustrating a configuration example of a pixel array unit 220 according to a modification of the fourth embodiment of the present technology. The pixel array unit 220 according to the modification of the fourth embodiment is different from the fourth embodiment in that only phase difference pixels 223 are arranged and no normal pixels 222 are arranged. Since the phase difference pixel 223 is arranged in place of the normal pixel 222 as described above, the number of the phase difference pixels 223 is increased and the distance measurement accuracy is improved accordingly.

Furthermore, a signal processing unit 121 according to the modification of the fourth embodiment generates pixel data by addition or calculation of an addition average for each phase difference pixel 223.

As described above, in the modification of the fourth embodiment of the present technology, the phase difference pixels 223 are arranged in place of the normal pixels 222. Therefore, the number of phase difference pixels 223 is increased and the distance measurement accuracy can be improved accordingly.

<5. Application Examples to Moving Bodies>

The technology according to the present disclosure (present technology) can be applied to various products. For example, the technology according to the present disclosure may be realized as a device mounted on any type of moving bodies including an automobile, an electric automobile, a hybrid electric automobile, an electric motorcycle, a bicycle, a personal mobility, an airplane, a drone, a ship, a robot and the like.

FIG. 20 is a block diagram illustrating a schematic configuration example of a vehicle control system as an example of a moving body control system to which the technology according to the present disclosure is applicable.

A vehicle control system 12000 includes a plurality of electronic control units connected through a communication network 12001. In the example illustrated in FIG. 20, the vehicle control system 12000 includes a drive system control unit 12010, a body system control unit 12020, a vehicle exterior information detection unit 12030, a vehicle interior information detection unit 12040, and an integrated control unit 12050. Furthermore, as functional configurations of the integrated control unit 12050, a microcomputer 12051, a sound image output unit 12052, and an in-vehicle network interface (I/F) 12053 are illustrated.

The drive system control unit 12010 controls operations of devices regarding a drive system of a vehicle according to various programs. For example, the drive system control unit 12010 functions as a control device of a drive force generation device for generating drive force of a vehicle, such as an internal combustion engine or a drive motor, a drive force transmission mechanism for transmitting drive force to wheels, a steering mechanism that adjusts a steering angle of a vehicle, a braking device that generates braking force of a vehicle and the like.

The body system control unit 12020 controls operations of various devices equipped in a vehicle body according to various programs. For example, the body system control unit 12020 functions as a control device of a keyless entry system, a smart key system, an automatic window device, and various lamps such as head lamps, back lamps, brake lamps, turn signals, and fog lamps. In this case, radio waves transmitted from a mobile device substituted for a key or signals of various switches can be input to the body system control unit 12020. The body system control unit 12020 receives an input of the radio waves or the signals, and controls a door lock device, the automatic window device, the lamps, and the like of the vehicle.

The vehicle exterior information detection unit 12030 detects information outside the vehicle that mounts the vehicle control system 12000. For example, an imaging unit 12031 is connected to the vehicle exterior information detection unit 12030. The vehicle exterior information detection unit 12030 causes the imaging unit 12031 to image an image outside the vehicle, and receives the imaged image. The vehicle exterior information detection unit 12030 may perform object detection processing or distance detection processing of persons, vehicles, obstacles, signs, letters or the like on a road surface on the basis of the received image.

The imaging unit 12031 is an optical sensor that receives light and outputs an electrical signal according to the amount of received light. The imaging unit 12031 can output the electrical signal as an image and can output the electrical signal as information of distance measurement. Furthermore, the light received by the imaging unit 12031 may be visible light or may be non-visible light such as infrared light.

The vehicle interior information detection unit 12040 detects information inside the vehicle. A driver state detection unit 12041 that detects a state of a driver is connected to the vehicle interior information detection unit 12040, for example. The driver state detection unit 12041 includes a camera that images the driver, for example, and the vehicle interior information detection unit 12040 may calculate the degree of fatigue or the degree of concentration of the driver, or may determine whether the driver falls asleep on the basis of the detection information input from the driver state detection unit 12041.

The microcomputer 12051 calculates a control target value of the drive power generation device, the steering mechanism, or the braking device on the basis of the information outside and inside the vehicle acquired in the vehicle exterior information detection unit 12030 or the vehicle interior information detection unit 12040, and can output a control command to the drive system control unit 12010. For example, the microcomputer 12051 can perform cooperative control for the purpose of realization of an advanced driver assistance system (ADAS) function including collision avoidance or shock mitigation of the vehicle, following travel based on an inter-vehicle distance, vehicle speed maintaining travel, collision warning of the vehicle, lane out warning of the vehicle and the like.

Furthermore, the microcomputer 12051 controls the drive power generation device, the steering mechanism, the braking device or the like on the basis of the information of a vicinity of the vehicle acquired in the vehicle exterior information detection unit 12030 or the vehicle interior information detection unit 12040 to perform cooperative control for the purpose of automatic driving of autonomous travel without depending on an operation of the driver or the like.

Furthermore, the microcomputer 12051 can output a control command to the body system control unit 12020 on the basis of the information outside the vehicle acquired in the vehicle exterior information detection unit 12030. For example, the microcomputer 12051 can perform cooperative control for the purpose of achievement of non-glare by controlling the head lamps according to the position of a leading vehicle or an oncoming vehicle detected in the vehicle exterior information detection unit 12030, switching high beam light to low beam light and the like.

The sound image output unit 12052 transmits an output signal of at least one of a sound or an image to an output device that can visually and aurally notify information to a passenger of the vehicle or an outside of the vehicle. In the example in FIG. 20, as the output device, an audio speaker 12061, a display unit 12062, and an instrument panel 12063 are exemplarily illustrated. The display unit 12062 may include, for example, at least one of an on-board display or a head-up display.

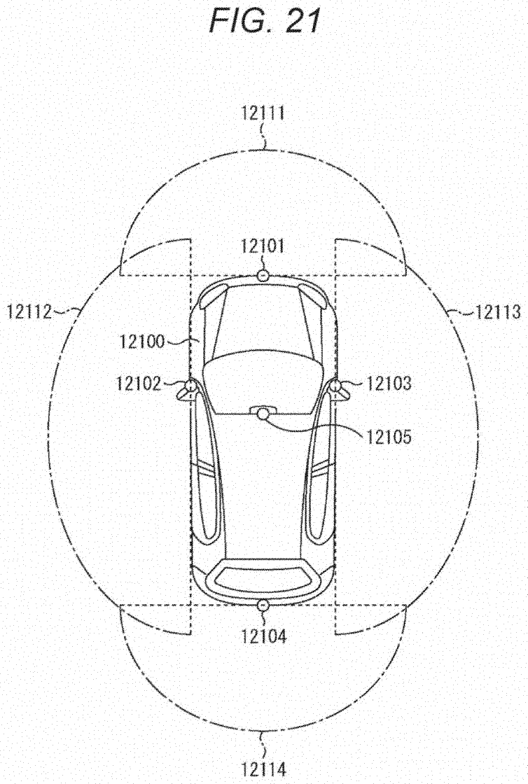

FIG. 21 is a diagram illustrating an example of an installation position of the imaging unit 12031.

In FIG. 21, imaging units 12101, 12102, 12103, 12104, and 12105 are included as the imaging unit 12031.

The imaging units 12101, 12102, 12103, 12104, and 12105 are provided at positions such as a front nose, side mirrors, a rear bumper or a back door, and an upper portion of a windshield in an interior of the vehicle 12100, for example. The imaging unit 12101 provided at the front nose and the imaging unit 12105 provided at an upper portion of the windshield in an interior of the vehicle mainly acquire front images of the vehicle 12100. The imaging units 12102 and 12103 provided at the side mirrors mainly acquire side images of the vehicle 12100. The imaging unit 12104 provided at the rear bumper or the back door mainly acquires a rear image of the vehicle 12100. The imaging unit 12105 provided at the upper portion of the windshield in the interior of the vehicle is mainly used for detecting a preceding vehicle, a pedestrian, an obstacle, a traffic signal, a traffic sign, a lane, or the like.

Note that FIG. 21 illustrates an example of imaging ranges of the imaging units 12101 to 12104. An imaging range 12111 indicates the imaging range of the imaging unit 12101 provided at the front nose, imaging ranges 12112 and 12113 respectively indicate the imaging ranges of the imaging units 12102 and 12103 provided at the side mirrors, and an imaging range 12114 indicates the imaging range of the imaging unit 12104 provided at the rear bumper or the back door. For example, a bird's-eye view image of the vehicle 12100 as viewed from above can be obtained by superimposing image data imaged in the imaging units 12101 to 12104.

At least one of the imaging units 12101 to 12104 may have a function to acquire distance information. For example, at least one of the imaging units 12101 to 12104 may be a stereo camera including a plurality of imaging elements or may be an imaging element having pixels for phase difference detection.

For example, the microcomputer 12051 obtains distances to three-dimensional objects in the imaging ranges 12111 to 12114 and temporal change of the distances (relative speeds to the vehicle 12100) on the basis of the distance information obtained from the imaging units 12101 to 12104, thereby to extract particularly a three-dimensional object closest to the vehicle 12100 on a traveling road and traveling at a predetermined speed (for example, 0 km/h or more) in substantially the same direction as the vehicle 12100 as a leading vehicle. Moreover, the microcomputer 12051 can set an inter-vehicle distance to be secured from the leading vehicle in advance and perform automatic braking control (including following stop control) and automatic acceleration control (including following start control), and the like. In this way, the cooperative control for the purpose of automatic driving of autonomous travel without depending on an operation of the driver or the like can be performed.

For example, the microcomputer 12051 classifies three-dimensional object data regarding three-dimensional objects into two-wheeled vehicles, ordinary cars, large vehicles, pedestrians, and other three-dimensional objects such as electric poles to be extracted, on the basis of the distance information obtained from the imaging units 12101 to 12104, and can use the data for automatic avoidance of obstacles. For example, the microcomputer 12051 discriminates obstacles around the vehicle 12100 into obstacles visually recognizable by the driver of the vehicle 12100 and obstacles visually unrecognizable by the driver. Then, the microcomputer 12051 determines a collision risk indicating a risk of collision with each of the obstacles, and can perform drive assist for collision avoidance by outputting warning to the driver through the audio speaker 12061 or the display unit 12062, and performing forced deceleration or avoidance steering through the drive system control unit 12010, in a case where the collision risk is a set value or more and there is a collision possibility.

At least one of the imaging units 12101 to 12104 may be an infrared camera that detects infrared light. For example, the microcomputer 12051 determines whether or not a pedestrian exists in the imaged images of the imaging units 12101 to 12104, thereby to recognize the pedestrian. The recognition of a pedestrian is performed by a process of extracting characteristic points in the imaged images of the imaging units 12101 to 12104, as the infrared camera, for example, and by a process of performing pattern matching processing for the series of characteristic points indicating a contour of an object and discriminating whether or not the object is a pedestrian. When the microcomputer 12051 determines that a pedestrian exists in the imaged images of the imaging units 12101 to 12104 and recognizes the pedestrian, the sound image output unit 12052 controls the display unit 12062 to superimpose and display a square contour line for emphasis on the recognized pedestrian. Furthermore, the sound image output unit 12052 may control the display unit 12062 to display an icon or the like representing the pedestrian at a desired position.

As described above, an example of a vehicle control system to which the technology according to the present disclosure is applicable has been described. The technology according to the present disclosure is applicable to the vehicle exterior information detection unit 12030 and the imaging unit 12031, of the above-described configurations. Specifically, the imaging lens 111, the solid-state image sensor 200, and the imaging control unit 140 in FIG. 1 are arranged in the imaging unit 12031, and the signal processing unit 120, the distance measuring sensor 150, and the distance measurement calculation unit 160 in FIG. 1 are arranged in the vehicle exterior information detection unit 12030. By application of the technology according to the present disclosure to the vehicle exterior information detection unit 12030 and the imaging unit 12031, a processing amount of a frame can be reduced.

Note that the above-described embodiments describe an example for embodying the present technology, and the matters in the embodiments and the matters used to specify the invention in the claims have correspondence, respectively. Similarly, the matters used to specify the invention in the claims and the matters in the embodiment of the present technology given the same names have correspondence, respectively. However, the present technology is not limited to the embodiments, and can be embodied by application of various modifications to the embodiments without departing from the gist of the present technology.

Furthermore, the processing procedures described in the above embodiments may be regarded as a method having these series of procedures, and also regarded as a program for causing a computer to execute these series of procedures and as a recording medium for storing the program. As this recording medium, for example, a compact disc (CD), a mini disc (MD), a digital versatile disc (DVD), a memory card, a Blu-ray (registered trademark) disc, or the like can be used.

Note that the effects described in the present description are merely examples and are not limited, and other effects may be exerted.

Note that the present technology can also have the following configurations.

(1) An imaging device including:

a distance measuring sensor configured to measure a distance for each of a plurality of regions to be imaged;

a control unit configured to generate a signal instructing a data rate for each of the plurality of regions on the basis of the distance and supply the signal as a control signal; and

an imaging unit configured to image a frame including the plurality of regions according to the control signal.

(2) The imaging device according to (1), in which

the data rate includes resolution.

(3) The imaging device according to (1) or (2), in which

the data rate includes a frame rate.

(4) The imaging device according to any one of (1) to (3), in which

the control unit changes the data rate depending on whether or not the distance is within a depth of field of an imaging lens.

(5) The imaging device according to any one of (1) to (4), in which

the control unit calculates a diameter of a circle of confusion from the distance and instructs the data rate according to the diameter.

(6) The imaging device according to any one of (1) to (5), further including:

a signal processing unit configured to execute predetermined signal processing for the frame.

(7) The imaging device according to (6), in which

the distance measuring sensor includes a plurality of phase difference detection pixels for detecting a phase difference of a pair of images,

the imaging unit includes a plurality of normal pixels, each normal pixel receiving light, and

the signal processing unit generates the frame from an amount of received light of each of the plurality of phase difference detection pixels and the plurality of normal pixels.

(8) The imaging device according to (6), in which

the distance measuring sensor includes a plurality of phase difference detection pixels for detecting a phase difference of a pair of images,

the signal processing unit generates the frame from an amount of received light of each of the plurality of phase difference detection pixels.

(9) A method of controlling an imaging device, the method including:

a distance measuring process of measuring a distance for each of a plurality of regions to be imaged;

a control process of generating a signal instructing a data rate for each of the plurality of regions on the basis of the distance and supplying the signal as a control signal; and

an imaging process of imaging a frame including the plurality of regions according to the control signal.

### REFERENCE SIGNS LIST

100 Imaging device
110 Lens unit
111 Imaging lens
112 Diaphragm
113 Lens parameter holding unit
114 Lens drive unit
115 Diaphragm control unit
120, 121 Signal processing unit
130 Setting information storage unit
140 Imaging control unit
141 Lens parameter acquisition unit
142 Exposure control unit
143 Autofocus control unit
144 Zoom control unit
145 Data rate control unit
150 Distance measuring sensor
153 Distance measuring area
160 Distance measurement calculation unit
161 Phase difference detection unit
200, 205 Solid-state image sensor
201 Upper substrate
202 Lower substrate
210, 151 Scanning circuit
220, 152 Pixel array unit
221 Unit area
222 Normal pixel
223 Phase difference pixel
224 Microlens
225 L-side photodiode
226 R-side photodiode
230, 154 AD conversion unit
231 ADC
12030 Vehicle exterior information detection unit
12031 Imaging unit

1. An imaging device comprising:
a distance measuring sensor configured to measure a distance for each of a plurality of regions to be imaged;
a control unit configured to generate a signal instructing a data rate for each of the plurality of regions on a basis of the distance and supply the signal as a control signal; and
an imaging unit configured to image a frame including the plurality of regions according to the control signal.

2. The imaging device according to claim 1, wherein
the data rate includes resolution.

3. The imaging device according to claim 1, wherein
the data rate includes a frame rate.

4. The imaging device according to claim 1, wherein
the control unit changes the data rate depending on whether or not the distance is within a depth of field of an imaging lens.

5. The imaging device according to claim 1, wherein
the control unit calculates a diameter of a circle of confusion from the distance and instructs the data rate according to the diameter.

6. The imaging device according to claim 1, further comprising:
a signal processing unit configured to execute predetermined signal processing for the frame.

7. The imaging device according to claim 6, wherein
the distance measuring sensor includes a plurality of phase difference detection pixels for detecting a phase difference of a pair of images,
the imaging unit includes a plurality of normal pixels, each normal pixel receiving light, and
the signal processing unit generates the frame from an amount of received light of each of the plurality of phase difference detection pixels and the plurality of normal pixels.

8. The imaging device according to claim 6, wherein
the distance measuring sensor includes a plurality of phase difference detection pixels for detecting a phase difference of a pair of images,
the signal processing unit generates the frame from an amount of received light of each of the plurality of phase difference detection pixels.

9. A method of controlling an imaging device, the method comprising:
a distance measuring process of measuring a distance for each of a plurality of regions to be imaged;
a control process of generating a signal instructing a data rate for each of the plurality of regions on a basis of the distance and supplying the signal as a control signal; and
an imaging process of imaging a frame including the plurality of regions according to the control signal.
